(19) United States
(12) Patent Application Publication
(10) Pub. No.: US 2005/0227848 A1
(43) Pub. Date: Oct. 13, 2005

(54) Solid bowl screw centrifuge comprising a peeling disk, and method for the operation thereof

(76) Inventors: Wilhelm Ostkamp, Oelde (DE); Franz Kramer, Ennigerloh (DE); Wolf-Dietrich Herberg, Durchholzer Strasse (DE)

Correspondence Address: BARNES & THORNBURG, 750-17TH STREET NW, SUITE 900, WASHINGTON, DC, 20006, US

(21) Appl. No.: 10/513,927

(22) PCT Filed: May 27, 2003
(86) PCT No.: PCT/EP03/05530

§ 371 Date: Nov. 10, 2004

(30) Foreign Application Priority Data
May 29, 2002 (DE) 102 23 802.2

(51) Int. Cl. B04B 11/08

(52) U.S. Cl. 494/53

(57) ABSTRACT

A solid bowl screw centrifuge includes a centrifuging chamber and a rotatable drum having a horizontal axis of rotation. The rotatable drum surrounds the centrifuging chamber. Also included is a rotatable screw arranged in the rotatable drum, at least one solids discharge, at least one liquid discharge duct and a peeling disk via which liquids are discharged through the liquid discharge duct. Further included is a blocking chamber connected to an output side of the peeling disk.

The invention relates to a solid bowl screw centrifuge according to the preamble of Claim 1 and to a method for its operation.

The solid bowl screw centrifuge disclosed in German Patent Document DE 43 20 265 A1 is equipped with a weir on the liquid outlet side, which weir has a passage. An orifice plate, which is stationary relative to the drum during its rotation, is assigned to the passage. By way of a threaded bush, this orifice plate is axially displaceable. By rotating the threaded bush, the distance between the weir and the orifice plate can be changed. The resulting change of the outflow cross-section causes a change of the liquid level in the centrifugal drum, so that a continuous adjustment of this liquid level can be achieved by displacing the orifice plate.

From German Patent Document DE 39 04 151 A1, a diaphragm plate situated on the screw is known. Nozzles on the outer circumference are used for minimizing the energy consumption. A processing of sensitive products with a gas-tight sealing-off with respect to the environment cannot be achieved by means of this construction.

From German Patent Document DE 198 30 653 C1 of the above-mentioned type, it is known to implement the liquid discharge of an open solid bowl screw centrifuge by means of a peeling disk which is followed by a labyrinth seal, in order to return product droplets to the peeling disk. According to this construction, no sealing-off is required with respect to the exterior space. However, solid bowl screw centrifuges with peeling disks in the case of which the product space is sealed off toward the outside are also in demand. It is an object of the invention to implement such a solid bowl screw centrifuge by means of simple constructive devices.

The invention achieves this task by means of the object of Claim 1. Accordingly, the chamber has an annulus with a first blocking and siphon disk arranged therein. The chamber is a hydrohermetic blocking chamber for sealing off the centrifuging chamber against the surroundings by means of a sealing liquid to which a feed line is directly assigned for the separate sealing liquid independent of the centrifuge material.

By means of the invention, a simple method of operating the centrifuge according to the invention is to be provided. This is indicated in Claim 15. Accordingly, a separate sealing liquid independent of the centrifuge material is fed through a feed line into the hydrohermetic blocking chamber—for sealing off the centrifuging chamber with respect to the surroundings.

The screw preferably has a siphon disk which extends from the screw radially to the outside into the centrifuging chamber.

In a constructively simple and cost-effective manner, the blocking chamber with the sealing liquid supply—preferably in combination with the two blocking or siphon disks—permits a reliable sealing-off of the centrifuging chamber with respect to the surrounding atmosphere. In contrast, in German Patent Document DE 198 30 653 C1 of the above-mentioned type, the product can still come in contact with the surrounding atmosphere because of the labyrinth seal.

Blocking chambers are also known per se from centrifuges with a vertical axis of rotation, a separate sealing liquid also being guided into these blocking chambers (German Patent Document DE 196 31 226). Blocking chambers in the case of such separators are also known from German Patent Document DE 657 473. However, it has not been considered and apparently also not been seen as being advantageous to implement a blocking chamber also in the case of centrifuges with a horizontal axis of rotation which blocking chamber is acted upon by a separate sealing liquid independent of the centrifuge material.

When a pressure is built up in the interior of the decanter or of the solid bowl screw centrifuge, a gas (such as CO2) dissolved in the centrifuge product (for example, a beverage) would under certain circumstances partially escape from the solid bowl screw centrifuge without the blocking chamber arrangement with two siphon disks and the sealing liquid feed. This is prevented by the invention.

By means of the blocking or siphon disk in the blocking chamber, sufficient pressure can be built up in a simple manner, so that a gas, such as CO2, is kept in the liquid (phase). By varying the diameter of the blocking and siphon disk, the pressure in the blocking chamber can be varied, which preferably amounts to up to 4 bar, particularly 0.5 to 2.5 bar. The pressure influences the type of the conveyance of the solids and/or their consistency.

Particularly preferably, the feed line and a discharge bore lead into an annulus of the blocking chamber and permit the continuous feeding and discharging of the sealing liquid into the blocking chamber and out of the blocking chamber. As a result, a continuous cleaning of the blocking chamber can be implemented in a much simpler manner than in German Patent Document DE 196 31 226 A1, and, as a result, the forming of deposits in the blocking chamber can be effectively prevented. The centrifuge therefore also meets high hygienic requirements.

Since the liquid discharge takes place by means of a peeling disk which is followed, particularly in a direct manner, by the blocking chamber, a dissolved gas, such as CO2, can be kept at least largely in the liquid to be discharged or to be processed, which considerably simplifies the processing of products, such as beer.

In particular, the blocking chamber as well as the peeling disk are arranged on the drum side or toward the drum with respect to the main bearing of the drum, which permits a very simple further development of the construction. This results not only in a durable sealing-off with respect to the surrounding atmosphere but, under certain circumstances, also in a sealing-off with respect to product contamination by oil mist of the liquid-side main bearing (not shown here).

Additional advantageous further developments are contained in the remaining subclaims.

In the following, the invention will be explained in detail by means of embodiments with respect to the drawing.

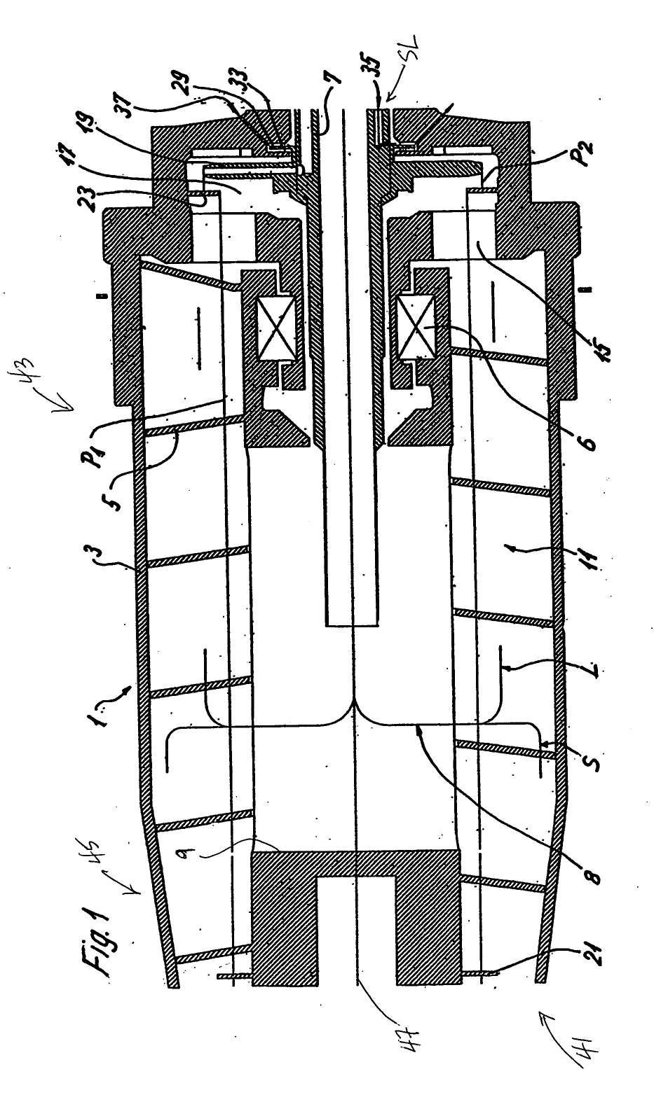

FIG. 1 is a sectional view of a solid bowl screw centrifuge according to the invention; and

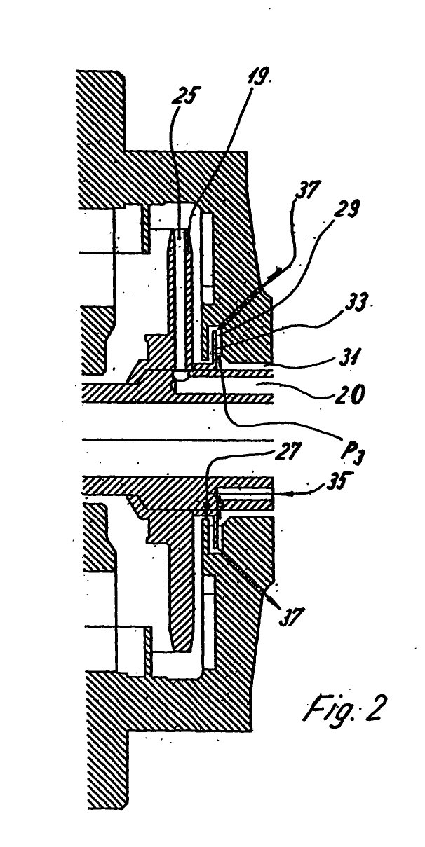

FIG. 2 is an enlargement of the cutout from FIG. 1.

FIG. 1 illustrates a solid bowl screw centrifuge 1 with a drum 3 having a horizontal axis of rotation in which a screw is arranged. The drum 3 and the screw 5 each of an essentially cylindrical section and a section which conically tapers here.

An axially extending centric feed pipe 7 is used for feeding the centrifuge material 8 by way of a distributor 9, which here is perpendicular with respect to the feed pipe 7, into the centrifuging chamber 11 between the screw 5 and the drum 3.

When, for example, a sludgy pulp is fed into the centrifuge, solid particles are deposited on the drum wall. A liquid phase develops farther toward the inside.

The screw 5 disposed by means of the bearing 6 rotates at a slightly lower or higher speed than the drum 3 and conveys the centrifuged solids S toward the conical section out of the drum 3 to a solids discharge (not shown here).

In contrast, the liquid flows to the larger drum diameter at the rearward end of the cylindrical section of the drum 3 and is guided there through a weir 15 into a chamber 17 which axially adjoins the actual centrifuging chamber and has a diameter which is smaller in comparison to the centrifuging chamber.

A peeling disk 19 for discharging the liquid phase L is arranged in the chamber 17 (see also FIG. 2), which is adjoined by a discharge duct 20 discharging the liquid phase L from the drum 3. The peeling disk 19 is arranged directly on the feed pipe 7 which is stationary during the operation, a sealed-off gap-free arrangement being implemented between the peeling disk 19 and the feed pipe 7.

Preferably in the conically tapering area of the drum 3, the screw 1—in front of the solids discharge (not shown here)—has a first siphon disk 21 which extends from the screw 5 radially toward the outside into the centrifuging chamber 11 and is immersed into the liquid level P1.

As a result of the immersion, the interior area or the centrifuging area in the centrifuging chamber 11 (here, to the right of the siphon disk 21) are hermetically sealed off with respect to the surroundings or the surrounding atmosphere. It would also be conceivable to arrange additional siphon disks in the conical area of the drum 3 in order to influence the consistency of the solids in this manner (not shown here).

In the chamber 17, a ring shoulder 23 is arranged on the side of the peeling disk 19 pointing to the centrifuging chamber, which ring shoulder 23 extends radially from the inner circumference of the chamber 17 toward the inside.

A liquid level P1 forms between the first siphon disk 21 and the ring shoulder 23 during the operation of the centrifuge because the siphon disk 21 and the ring shoulder overlap in the radial direction or because the two elements are correspondingly adapted to one another.

In contrast, between the ring shoulder 23 situated closer to the peeling disk 19 and the peeling disk 19, the liquid level P2 extends to the inlet opening 25 of the peeling disk. The liquid level can be varied here by slightly (? translator) throttling the peeling disk 19.

On the side of the peeling disk 19 facing away from the ring disk 23 (shoulder? translator), the chamber 17 extends radially toward the inside to close to the feed pipe or to a diameter smaller than the diameter of the screw 5, and leads into an axial passage 27 which is adjoined in the axial direction by an annulus 29 which acts as a blocking chamber and which, in turn, leads into an axial discharge duct 31 for the sealing liquid on the outer circumference of the feed pipe 7 and of the discharge duct 31 for the centrifuge material, the inside diameter of the discharge duct 31 for the sealing liquid being smaller than the inside diameter of the passage 27, so that sealing liquid overflowing from the blocking chamber 19 flows out through the discharge duct 31.

In the blocking chamber or in the annulus 29, another siphon or blocking disk 33 is stationarily arranged on its inner circumference and extends from the inside radially to the outside into the blocking chamber.

An feed line 35—here arranged parallel to the feed pipe 7 on its outer circumference—leading into the centrifuge from the outside permits the direct feeding of sealing liquid, such as water, which is independent of the centrifuge material, from the inside into the blocking chamber 29.

A discharge bore 37—here, leading on the circumference of the annulus 29 at an acute angle with respect to the axis of rotation radially to the outside out of the drum 3—permits the continuous discharge of sealing liquid from the annulus 29, which causes an advantageous cleaning.

During the operation—that is, during rotations of the drum 3 and the screw 5—a liquid level P3 of the sealing liquid forms in the annulus 29, which liquid level P3 seals off the interior of the drum 3 against the surrounding atmosphere when the feeding amount of sealing liquid into the blocking chamber is larger than the discharge amount, which is adjusted by the dimensioning of the discharge bore 37. Excess water which does not flow off through the discharge bore 37 flows off through the discharge duct 31.

By means of the second siphon disk 33 in the blocking chamber 29, however, a sufficient pressure can be built up in a simple manner, so that gas is kept in the liquid. By varying the diameter of the blocking and siphon disk 33, the pressure in the blocking chamber 29 can be varied. The pressure influences the type of the conveyance of the solids and/or their consistency.

### LIST OF REFERENCE NUMBERS

Solid bowl screw centrifuge 1
bearing 2
drum 3
screw 5
feed pipe 7
centrifuge material 8
distributor 9
centrifuging chamber 11
discharge duct 13
weir 15
chamber 17
peeling disk 19
discharge duct 20
blocking and siphon disk 21
ring shoulder 23
inlet opening 25
passage 27
annulus 29
discharge duct 31
blocking and siphon disk 33
feed line 35
discharge bore 37
liquid level P1, P2, P3
centrifuge material S

1. A solid bowl screw centrifuge, comprising:
a centrifuging chamber;
a rotatable drum having a horizontal axis of rotation, the rotatable drum surrounding the centrifuging chamber;
a rotatable screw arranged in the rotatable drum;
at least one solids discharge;
at least one liquid discharge duct;
a peeling disk via which liquids are discharged through the liquid discharge duct;
a blocking chamber connected to an output side of the peeling disk, the blocking chamber including an annulus having a first siphon disk arranged therein, the blocking chamber being a hydrohermetic blocking chamber to seal off the centrifuging chamber from its surroundings via a sealing liquid that is independent of material to be centrifuged;
a feed line assigned to the blocking chamber to feed the sealing liquid; and
wherein the rotatable screw includes a second siphon disk extending from the screw radially to the outside into the centrifuging chamber.

2. (canceled)

3. The solid bowl screw centrifuge according to claim 1 wherein the blocking chamber is connected directly behind the peeling disk.

4. The solid bowl screw centrifuge according to claim 1, wherein the second siphon disk is arranged on the screw in front of the solids discharge.

5. The solid bowl screw centrifuge according to claim 4, wherein the second siphon disk is arranged on the screw in a conically tapering section of the rotatable drum.

6. The solid bowl screw centrifuge according to claim 1, further including a feed pipe and a discharge bore leading into the annulus and permitting a continuous feeding and discharging of the sealing liquid into and out of the blocking chamber.

7. The solid bowl screw centrifuge according to claim 1, wherein the rotatable drum and the rotatable screw each have an essentially cylindrical section and a tapering section, the centrifuge further including a peeling disk chamber adjoining the cylindrical section, the peeling disk chamber having a diameter that is smaller than a diameter of the centrifuging chamber and in which peeling disk chamber the peeling disk is situated.

8. The solid bowl screw centrifuge according to claim 7, wherein a ring shoulder is arranged on an inner circumference of the peeling disk chamber.

9. The solid bowl screw centrifuge according to claim 7, wherein the peeling disk chamber, on a side of the peeling disk facing away from the ring shoulder, extends radially to the inside of the rotatable drum to a diameter which is smaller than the diameter of the screw, and the peeling disk chamber leads into a passage which is adjoined in an axial direction by the annulus leading into an axial discharge duct for the sealing liquid, the inside diameter of discharge duct being smaller than that of the passage, so that sealing liquid overflowing from the blocking chamber 29 can be discharged through the discharge duct.

10. The solid bowl screw centrifuge according to claim 1, wherein the first siphon disk is one of attached and molded perpendicularly to an inner circumference of the blocking chamber having the annulus, which first siphon disk extends radially from the inside toward the outside of the drum and into the annulus.

11. The solid bowl screw centrifuge according to claim 1, wherein the feed line is arranged parallel to and on an outside circumference of a feed pipe for feeding material to be centrifuged.

12. The solid bowl screw centrifuge according to claim 1, wherein a discharge bore leads from an outer circumference of the annulus at an acute angle with respect to an axis of rotation of the drum and radially to the outside of the drum.

13. The solid bowl screw centrifuge according to claim 8, wherein the first siphon disk and the ring shoulder are mutually coordinated such that, during an operation of the centrifuge, a liquid level P₁ forms between them.

14. The solid bowl screw centrifuge according to claim 11, wherein the peeling disk is arranged in a sealed-off manner on the feed pipe which is stationary during an operation of the centrifuge.

15. A method of operating a solid bowl screw centrifuge, the solid bowl centrifuge including a centrifuging chamber, a rotatable drum surrounding the centrifuging chamber and having a horizontal axis of rotation, a rotatable screw arranged in the rotatable drum, at least one solids discharge, at least one liquid discharge duct, a peeling disk via which liquids are discharged through the liquid discharge duct, a blocking chamber connected to an output side of the peeling disk including an annulus having a first siphon disk arranged therein, a feed line assigned to the blocking chamber to feed the sealing liquid, and the rotatable screw includes a second siphon disk extending from the screw radially to the outside into the centrifuging chamber, the method steps comprising,
turning on the centrifuge; and
feeding a sealing liquid that is independent of the material to be centrifuged through the feed line into the blocking chamber to seal off the centrifuging chamber from its surroundings.

16. The method according to claim 15, further including the step of discharging the sealing liquid, thereby effecting a continuous cleaning of the blocking chamber.

17. The method according to claim 15, further including the step of adjusting pressure in the blocking chamber by varying a diameter of the first siphon disk.

18. The method according to claim 15, further including the step of providing a pressure in the centrifugal chamber of up to 4 bar.

19. The method according to claim 15, further including the step of providing a pressure in the blocking chamber of 0.5 to 2.5 bar.
